(19) United States
(12) Patent Application Publication
(10) Pub. No.: US 2024/0165841 A1
(43) Pub. Date: May 23, 2024

(54) MULTI-FUNCTIONAL CUTTER

(71) Applicant: Zhejiang Fullstar Houseware Co.,Ltd., Taizhou (CN)

(72) Inventor: Congqiang LU, Taizhou (CN)

(73) Assignee: Zhejiang Fullstar Houseware Co.,Ltd., Taizhou (CN)

(21) Appl. No.: 17/993,281

(22) Filed: Nov. 23, 2022

(51) Int. Cl. B26D 3/18; B26D 7/08; B26D 7/26

(52) U.S. Cl. CPC B26D 3/185; B26D 7/088; B26D 7/2614; B26D 7/2628; B26D 2007/0018; B26D 2210/02

(57) ABSTRACT

Disclosed is a multi-functional cutter. The cutter includes a box body with an opening formed in an upper end, wherein a drawer type containing box is slidably arranged in the box body, a plurality of functional assemblies match in a replaceable manner at the opening of the box body, and the functional assemblies at least include a dicing device and a platy cutting device. The multi-functional cutter has various functions and is convenient to use.

### TECHNICAL FIELD

The application belongs to the technical field of articles for daily life, and relates to a multi-functional cutter.

### BACKGROUND

Graters and dicing devices used in daily home kitchens can be found everywhere on the current market. The common grater is of a simple structure that a grating blade is added to a plastic handle for simple grating, but shreds made by grating have relatively single shapes. As for the common dicing device, fruits and vegetables are cut, by means of blades distributed in a grid shape, into pieces when passing the grid. It can be seen from the above kitchen appliances that there are various home kitchen appliances according to functions thereof, a consumer needs to take certain effort to collect one set of such appliances, meanwhile, the cost consumed is increased, and different sets of products also cause inconvenience in use.

### SUMMARY

Aiming at the defects of the prior art, the application provides a multi-functional cutter which has various functions and is convenient to use.

In order to solve the technical problems mentioned above, the purposes of the application are achieved through the following technical solution:
the multi-functional cutter comprises a box body with an opening formed in an upper end, wherein a drawer type containing box is slidably arranged in the box body; a plurality of functional assemblies match in a replaceable manner at the opening of the box body; the functional assemblies at least comprise a dicing device and a platy cutting device;
the dicing device comprises a dicing base and a dicing gland, the bottom of the dicing base is connected to the box body in a matching manner, the dicing gland is detachably articulated to the dicing base by means of a first locking assembly, a dicing pressing plate is detachably connected to the dicing gland by means of a second locking assembly, a reticulated knife board is detachably connected to the dicing base by means of a third locking assembly, and a plurality of square bumps matching the reticulated knife board are arranged at the bottom of the dicing pressing plate; and
the platy cutting device comprises a cutting bottom plate, the bottom of the cutting bottom plate is connected to the box body in a matching manner, a cutting knife board and a cutting panel are adjacently arranged on the cutting bottom plate, the cutting knife board is detachably connected to the cutting bottom plate by means of a fourth locking assembly, and an adjusting device for adjusting the height of the end of the cutting panel that is adjacent to the cutting knife board is arranged between the cutting bottom plate and the cutting panel.

In the above-mentioned multi-functional cutter, preferably, the opening of the box body matches the functional assemblies by means of a spigot structure.

In the above-mentioned multi-functional cutter, the first locking assembly, the second locking assembly, the third locking assembly and the fourth locking assembly may be of common detachable locking structures in the art, for example, detachable fasteners, detachable clamping structures, and knobs provided with locking bumps and capable of realizing rotatable unlocking. The preferred structures of the first locking assembly, the second locking assembly, the third locking assembly and the fourth locking assembly are further provided below.

The first locking assembly comprises a first locking base arranged above the dicing base, a pair of rotating shafts capable of sliding axially is arranged in the first locking base, a pair of rotating shaft holes matching the rotating shafts for locking is formed in an articulated end of the dicing gland, handles for driving the rotating shafts to move inwards are connected to the rotating shafts respectively, and first reset springs for driving the rotating shafts to move outwards are arranged between the rotating shafts and the first locking base respectively.

The second locking assembly comprises a second locking base fixed to the dicing gland, a second locking member is slidably arranged on the second locking base in a lengthwise direction, a second lock tongue is arranged at one end of the second locking member that is close to the dicing pressing plate, a second locking groove matching the second lock tongue for locking is formed at one end of the dicing pressing plate, and a second reset spring for driving the second locking member to slide in a locking direction is arranged between the second locking member and the second locking base.

The third locking assembly comprises a third locking base fixed to the dicing base, a third locking member is slidably arranged on the third locking base in a lengthwise direction, a third lock tongue is arranged at a front end of the third locking member, a third adjusting hole distributed in a widthwise direction is formed in a rear end of the third locking member, the third adjusting hole comprises a locking section and an unlocking section, a front side wall of the locking section is further away from the reticulated knife board than a front side wall of the unlocking section, a third strip-shaped hole corresponding to the third adjusting hole is formed in the dicing base, a third adjusting knob connected to a front side wall of the third adjusting hole in an abutting manner is slidably arranged in the third strip-shaped hole and the third adjusting hole, a third locking groove matching the third lock tongue for locking is formed at a rear end of the reticulated knife board, and a third reset spring for driving the third locking member to move away from the reticulated knife board is arranged between the third locking member and the third locking base.

The fourth locking assembly comprises a fourth lock tongue arranged on the cutting knife board, the fourth lock tongue is arranged at one end of the cutting knife board that is close to the cutting panel, a fourth locking groove matching the fourth lock tongue for locking is formed in the cutting bottom plate, a plurality of elastic clamping blocks clamped and fixed to the cutting bottom plate are arranged at one end of the cutting knife board that is far away from the cutting panel, limiting blocks are arranged above two sides of the fourth lock tongue, and the limiting blocks are connected to the bottom of the cutting panel in an abutting manner in an initial state.

In the above-mentioned multi-functional cutter, the height adjusting device comprises a sliding plate slidably arranged on the cutting bottom plate in a lengthwise direction, the cutting panel is located above the sliding plate, one end of the cutting panel that is far away from the cutting knife board is articulated with the cutting bottom plate, the other end of the cutting panel is a movable end, a pair of first ribs having gradually-changed stepped surfaces is arranged on a bottom plane of the movable end in a lengthwise direction, second ribs, corresponding to the first ribs, in a widthwise direction are arranged on the sliding plate, the cutting panel has different heights when the second ribs abut against the different stepped surfaces of the first ribs, a guide hole is obliquely formed in the sliding plate, an adjusting plate is slidably arranged in the guide hole by means of an adjusting pin, the adjusting plate drives the sliding plate to move forwards and backwards when moving in the widthwise direction, and a fifth adjusting knob for driving the adjusting plate to move is fixed to the adjusting plate.

In the above-mentioned multi-functional cutter, the reticulated knife board has different mesh sizes, and the dicing pressing plate having the square bumps matching meshes is selected.

In the above-mentioned multi-functional cutter, the cutting knife board is selected from following various cutting knife boards including:
a slicing knife board, wherein the slicing knife board is provided with a slicing blade with cutting edges distributed in a widthwise direction, and a slice discharge port is formed between the slicing blade and the slicing knife board;
a thick shred knife board, wherein the thick shred knife board is provided with a first thick shred blade with cutting edges distributed in a widthwise direction, a thick shred discharge port is formed between the first thick shred blade and the thick shred knife board, a plurality of second thick shred blades are arranged at one end of the thick shred knife board that is close to the cutting panel, the second thick shred blades are triangles perpendicular to the thick shred knife board, and cutting edges of the second thick shred blades are arranged on sides close to the cutting panel;
a thin shred knife board, wherein the thin shred knife board is provided with a plurality of staggered thin shred discharge ports, a thin shred blade bulging upwards is arranged at one end of each thin shred discharge port that is far away from the cutting panel, and each thin shred blade is of an arc-shaped structure and has one closed end and one open end;
a square shred knife board, wherein the square shred knife board is provided with a plurality of staggered square shred discharge ports, a square shred blade bulging upwards is arranged at one end of each square shred discharge port that is far away from the cutting panel, and each square shred blade is of a square structure and has one closed end and one open end;
a grinding knife board, wherein the grinding knife board is provided with a plurality of staggered pulp discharge ports, and a plurality of grinding blades bulging upwards are arranged around each pulp discharge port; and
a threshing knife board, wherein the threshing knife board is provided with a through hole, a threshing hole is coaxially formed in the through hole, a plurality of threshing blades are circumferentially arranged on the threshing hole, and a threshing discharge port is formed between the threshing hole and the through hole.

The multi-functional cutter further comprises a propeller matching the platy cutting device for use, wherein the propeller comprises a propeller base capable of spanning the platy cutting device, a plurality of vertically arranged pins are arranged in the propeller base, a pressing disc is vertically slidably arranged in the propeller base, a plurality of through holes allowing the pins to penetrate through are formed in the pressing disc, the pressing disc is connected, by means of a plurality of vertical guide columns, to a propelling button located above the propeller base, and the guide columns vertically penetrate through the propeller base.

The multi-functional cutter further comprises cleaning teeth, wherein the cleaning teeth comprise a handle portion and a toothed portion; and a knife board storage box is detachably arranged in the box body and is divided, by means of barriers, into a plurality of knife board storage spaces matching the reticulated knife board and the cutting knife board and cleaning tooth storage spaces matching the cleaning teeth.

Compared with the prior art, the application has the following beneficial effects:
food processing devices having multiple functions are combined, the functional assemblies are replaced quickly by combinations of multiple detachable manners, and the requirements of consumers for different food materials and different processing manners can be met. The application also has the advantages of simple structure, convenience in use, easiness in storage and small occupied space.

### BRIEF DESCRIPTION OF THE DRAWINGS

FIG. 1 is a stereogram of a whole set of assemblies of the application.

FIG. 2 is a stereogram of a dicing device of the application matching a box body for use.

FIG. 3 is a stereogram of a platy cutting device of the application matching the box body for use.

FIG. 4 is a stereogram of the box body of the application.

FIG. 5 is a stereogram of the dicing device of the application.

FIG. 6 is a stereogram of the platy cutting device of the application.

FIG. 7 is a stereogram of a second locking assembly of the application.

FIG. 8 is a stereogram of a third locking assembly of the application.

FIG. 9 is a stereogram of a height adjusting device of the application.

FIG. 10 is a stereogram of a slicing knife board of the application.

FIG. 11 is a stereogram of a thick shred knife board of the application.

FIG. 12 is a stereogram of a thin shred knife board of the application.

FIG. 13 is a stereogram of a square shred knife board of the application.

FIG. 14 is a stereogram of a grinding knife board of the application.

FIG. 15 is a stereogram of a threshing knife board of the application.

FIG. 16 is a stereogram of a propeller of the application.

FIG. 17 is a stereogram of cleaning teeth of the application.

FIG. 18 is a stereogram of a knife board storage box of the application.

FIG. 19 is a stereogram of the knife board storage box of the application after storage.

### DETAILED DESCRIPTION OF THE EMBODIMENTS

The application is further described below by particular embodiments in conjunction with accompanying drawings.

Referring to FIGS. 1-19, a multi-functional cutter comprises a box body 1 with an opening formed in an upper end, wherein a drawer type containing box 11 is slidably arranged in the box body 1; a plurality of functional assemblies match in a replaceable manner at the opening of the box body 1; the functional assemblies at least comprise a dicing device 2 and a platy cutting device 3;
the dicing device 2 comprises a dicing base 21 and a dicing gland, the bottom of the dicing base 21 is connected to the box body 1 in a matching manner, the dicing gland is detachably articulated to the dicing base 21 by means of a first locking assembly 10, a dicing pressing plate 23 is detachably connected to the dicing gland by means of a second locking assembly 20, a reticulated knife board 24 is detachably connected to the dicing base 21 by means of a third locking assembly 30, and a plurality of square bumps 25 matching the reticulated knife board 24 are arranged at the bottom of the dicing pressing plate 23; and
the platy cutting device 3 comprises a cutting bottom plate 31, the bottom of the cutting bottom plate 31 is connected to the box body 1 in a matching manner, a cutting knife board 32 and a cutting panel 33 are adjacently arranged on the cutting bottom plate 31, the cutting knife board 32 is detachably connected to the cutting bottom plate 31 by means of a fourth locking assembly 40, and an adjusting device for adjusting the height of the end of the cutting panel 33 that is adjacent to the cutting knife board 32 is arranged between the cutting bottom plate 31 and the cutting panel 33.

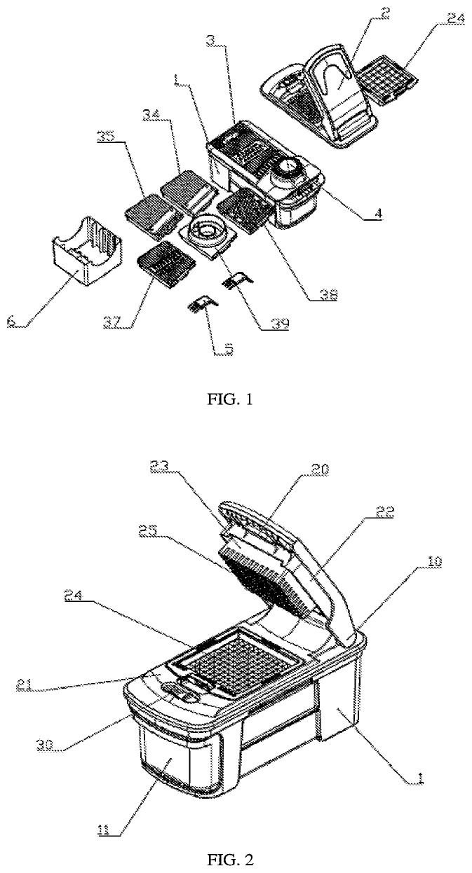

Referring to FIG. 2, when the box body matches the dicing device 2 for use, the needed dicing pressing plate 23 is replaced by means of the second locking assembly 20, the needed reticulated knife board 24 is replaced by means of a third locking assembly, then the dicing device 2 is mounted at the opening of the box body 1, food is placed between the dicing base 21 and the dicing gland and is cut into pieces by the reticulated knife board 24 under the downward pressure of the dicing gland, the pieces of food fall into the containing box 11, and the food can be taken out after the containing box 11 is pulled out; and after the dicing device is used, the dicing gland can be removed by means of the first locking assembly 10, the dicing pressing plate 23 can be removed by means of a second locking assembly, and the reticulated knife board 24 can be removed by means of the third locking assembly for cleaning.

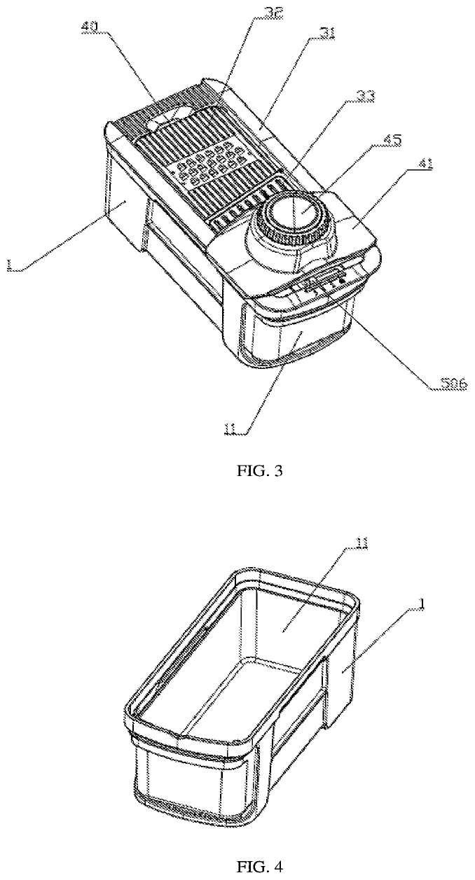

Referring to FIG. 3, when the box body matches the platy cutting device 3 for use, the needed cutting knife board 32 is replaced by means of the fourth locking assembly 40, the cutting panel 33 is adjusted to the proper height, different operations are carried out by means of the different cutting knife board 32 to process the food into different forms, the processed food falls into the containing box 11, and the food can be taken out after the containing box 11 is pulled out; and after the platy cutting device is used, the cutting knife board 32 can be removed by means of the fourth locking assembly 40 for cleaning.

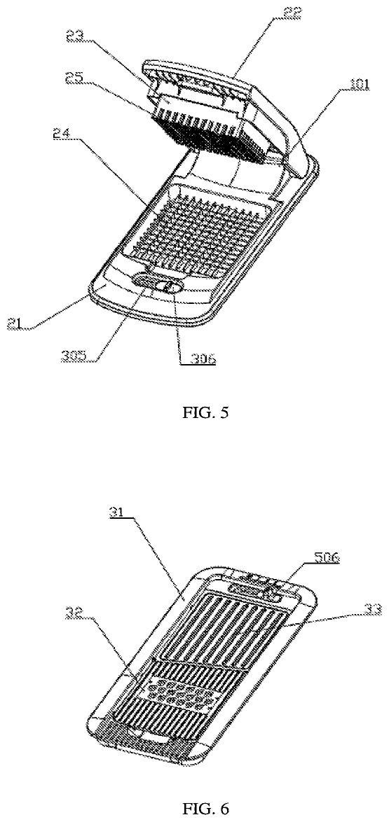

Referring to FIG. 2 and FIG. 5, the first locking assembly 10 comprises a first locking base 101 arranged above the dicing base 21, a pair of rotating shafts capable of sliding axially is arranged in the first locking base 101, a pair of rotating shaft holes matching the rotating shafts for locking is formed in an articulated end of the dicing gland, handles for driving the rotating shafts to move inwards are connected to the rotating shafts respectively, and first reset springs for driving the rotating shafts to move outwards are arranged between the rotating shafts and the first locking base 101 respectively.

Unlocking and locking manners of the first locking assembly 10 are as follows: in a locked state, the rotating shafts are slid inwards simultaneously by means of the handles to compress the first reset springs, ends of the rotating shafts are separated from the rotating shaft holes, and thus the dicing gland is separated from the dicing base 21; and in an unlocked state, the rotating shafts are slid inwards simultaneously by means of the handles to compress the first reset springs, the dicing gland is placed at a position where the rotating shaft holes correspond to the rotating shafts, then the handles are released, the first reset springs drive the rotating shafts to enter the rotating shaft holes to complete locking, and thus the dicing gland and the dicing base 21 are connected integrally.

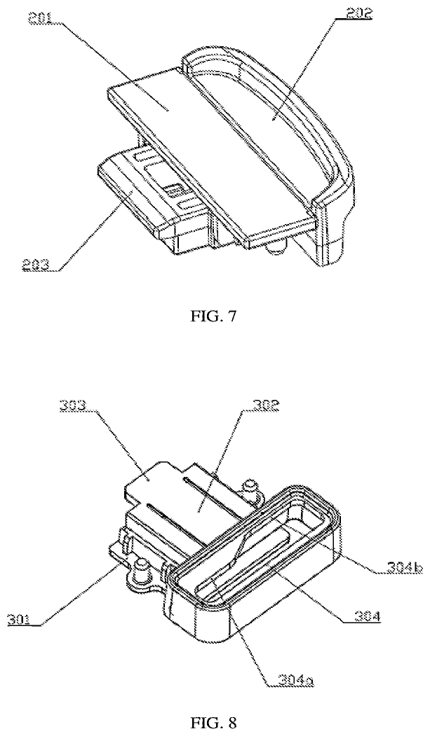

Referring to FIG. 2 and FIG. 7, the second locking assembly 20 comprises a second locking base 201 fixed to the dicing gland, a second locking member 202 is slidably arranged on the second locking base 201 in a lengthwise direction, a second lock tongue 203 is arranged at one end of the second locking member 202 that is close to the dicing pressing plate 23, a second locking groove matching the second lock tongue 203 for locking is formed at one end of the dicing pressing plate 23, and a second reset spring for driving the second locking member 202 to slide in a locking direction is arranged between the second locking member 202 and the second locking base 201.

Unlocking and locking manners of the second locking assembly 20 are as follows: in a locked state, the second locking member 202 is pulled to compress the second reset spring, the second locking member 202 drives the second lock tongue 203 to leave the second locking groove, and thus the dicing gland is separated from the dicing pressing plate 23; and in an unlocked state, the second locking member 202 is pulled to compress the second reset spring, the dicing pressing plate 23 is placed in a mounting groove of the dicing gland, then the second locking member 202 is released, the second reset spring drives the second lock tongue 203 to enter the second locking groove to complete locking, and thus the dicing gland and the dicing pressing plate 23 are connected integrally.

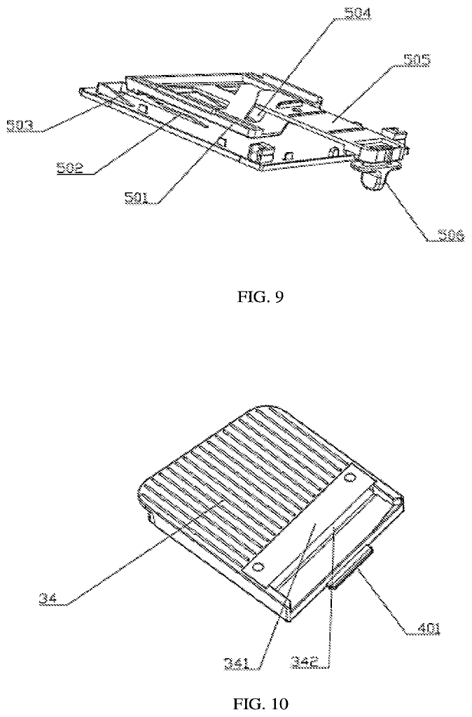

Referring to FIG. 5 and FIG. 8, the third locking assembly 30 comprises a third locking base 301 fixed to the dicing base 21, a third locking member 302 is slidably arranged on the third locking base 301 in a lengthwise direction, a third lock tongue 303 is arranged at a front end of the third locking member 302, a third adjusting hole 304 distributed in a widthwise direction is formed in a rear end of the third locking member, the third adjusting hole 304 comprises a locking section 304a and an unlocking section 304b, a front side wall of the locking section 304a is further away from the reticulated knife board 24 than a front side wall of the unlocking section 304b, a third strip-shaped hole 305 corresponding to the third adjusting hole 304 is formed in the dicing base 21, a third adjusting knob 306 connected to a front side wall of the third adjusting hole 304 in an abutting manner is slidably arranged in the third strip-shaped hole 305 and the third adjusting hole 304, a third locking groove matching the third lock tongue 303 for locking is formed at a rear end of the reticulated knife board 24, and a third reset spring for driving the third locking member 302 to move away from the reticulated knife board 24 is arranged between the third locking member 302 and the third locking base 301.

Unlocking and locking manners of the third locking assembly 30 are as follows: under the action of the third reset spring, the third adjusting knob 306 is always connected to the front side wall of the third adjusting hole 304 in the abutting manner, in a locked state, the third adjusting knob 306 is located at a locking position and is connected to a front side wall of the locking section 304a in an abutting manner, the third adjusting knob 306 is slid to an unlocking position, and the slid third adjusting knob 306 is connected to a front side wall of the unlocking section 304b in an abutting manner, at the same time, the third locking member 302 moves backwards and drives the third lock tongue 303 to be separated from the third locking groove, and thus the reticulated knife board 24 is separated from the dicing base 21; and in an unlocked state, the reticulated knife board 24 is placed in a mounting groove of the dicing base 21, the third adjusting knob 306 is located at the unlocking position and is connected to the front side wall of the unlocking section 304b in the abutting manner, the third adjusting knob 306 is slid to a locking position, the slid third adjusting knob 306 is connected to the front side wall of the locking section 304a in the abutting manner, at the same time, the third locking member 302 moves forwards and drives the third lock tongue 303 to enter the third locking groove, and thus the reticulated knife board 24 and the dicing base 21 are connected integrally.

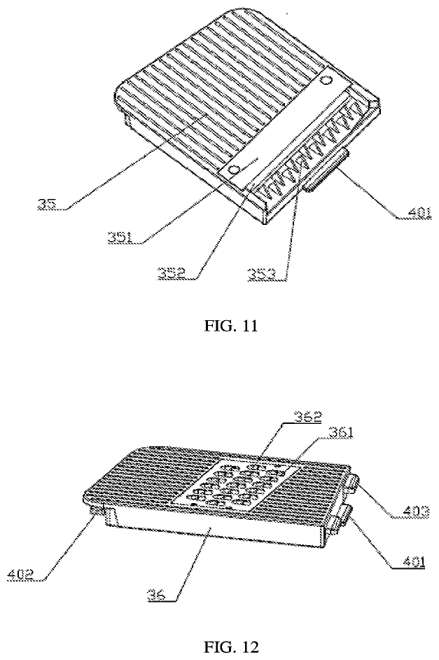

Referring to FIG. 3 and FIG. 12, the fourth locking assembly 40 comprises a fourth lock tongue 401 arranged on the cutting knife board 32, the fourth lock tongue 401 is arranged at one end of the cutting knife board 32 that is close to the cutting panel 33, a fourth locking groove matching the fourth lock tongue 401 for locking is formed in the cutting bottom plate 31, a plurality of elastic clamping blocks 402 clamped and fixed to the cutting bottom plate 31 are arranged at one end of the cutting knife board 32 that is far away from the cutting panel 33, limiting blocks 403 are arranged above two sides of the fourth lock tongue 401, and the limiting blocks 403 are connected to the bottom of the cutting panel 33 in an abutting manner in an initial state.

Unlocking and locking manners of the fourth locking assembly 40 are as follows: in a locked state, the end of the cutting knife board 32 that is provided with the elastic clamping blocks 402 is pulled upwards, thus the elastic clamping blocks 402 are separated from a clamping groove in the cutting bottom plate 31, and then the fourth lock tongue 401 is pulled out of the fourth locking groove; and in an unlocked state, the fourth lock tongue 401 is inserted into the fourth locking groove, then the end of the cutting knife board 32 that is provided with the elastic clamping blocks 402 is pressed downwards, and thus the elastic clamping blocks 402 are clamped in the clamping groove in the cutting bottom plate 31 to achieve locking.

Referring to FIG. 6 and FIG. 9, the height adjusting device comprises a sliding plate 501 slidably arranged on the cutting bottom plate 31 in a lengthwise direction, the cutting panel 33 is located above the sliding plate 501, one end of the cutting panel 33 that is far away from the cutting knife board 32 is articulated with the cutting bottom plate 31, the other end of the cutting panel is a movable end, a pair of first ribs 502 having gradually-changed stepped surfaces is arranged on a bottom plane of the movable end in a lengthwise direction, second ribs 503, corresponding to the first ribs 502, in a widthwise direction are arranged on the sliding plate 501, the cutting panel 33 has different heights when the second ribs 503 abut against the different stepped surfaces of the first ribs 502, a guide hole 504 is obliquely formed in the sliding plate 501, an adjusting plate 505 is slidably arranged in the guide hole 504 by means of an adjusting pin, the adjusting plate 505 drives the sliding plate 501 to move forwards and backwards when moving in the widthwise direction, and a fifth adjusting knob 506 for driving the adjusting plate 505 to move is fixed to the adjusting plate 505.

A manner for adjusting the height is as follows: the fifth adjusting knob 506 is slid, the adjusting plate 505 slides with the fifth adjusting knob, the adjusting pin slides along the guide hole 504 when the adjusting plate 505 slides, the guide hole 504 is obliquely formed, and thus the adjusting plate 505 pulls the sliding plate 501 to move forwards and backwards; and the second ribs 503 abut against the different stepped surfaces of the first ribs 502 respectively when the sliding plate 501 moves forwards and backwards, so that the cutting panel 33 has the different heights. The specifications of the cut food can be further changed by means of height adjustment.

The reticulated knife board 24 has different mesh sizes, the dicing pressing plate 23 having the square bumps 25 matching meshes is selected, and the food pieces in different sizes can be cut by means of the reticulated knife board 24 having the different mesh sizes.

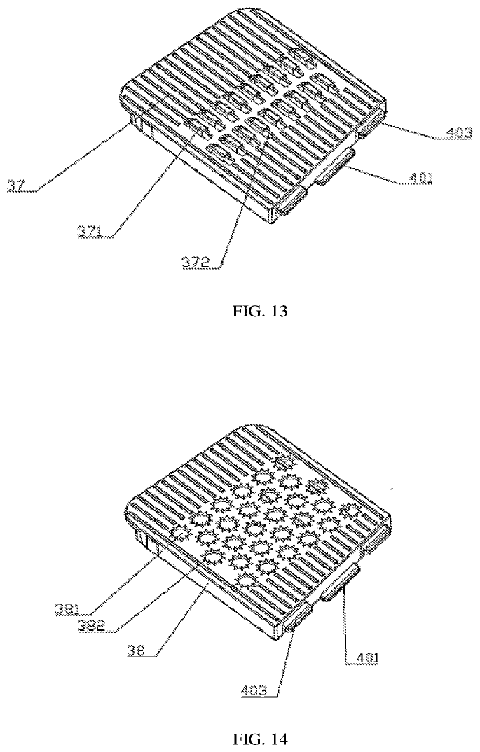

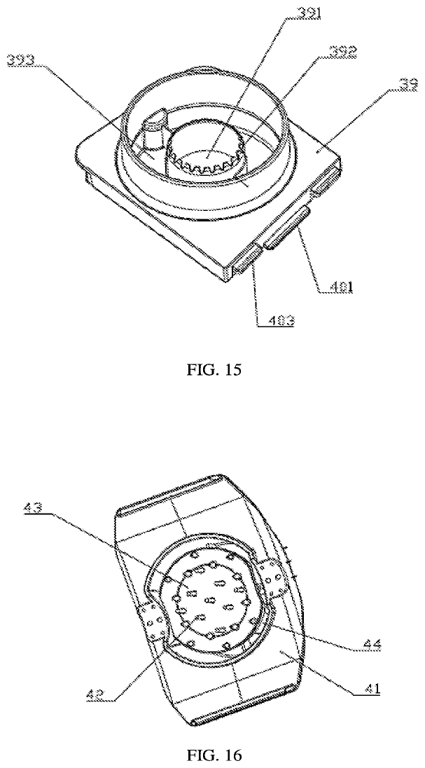

In order to meet various requirements, the cutting knife board 32 is selected from following various cutting knife boards 32 including:
referring to FIG. 10, a slicing knife board 34, wherein the slicing knife board 34 is provided with a slicing blade 341 with cutting edges distributed in a widthwise direction, a slice discharge port 342 is formed between the slicing blade 341 and the slicing knife board 34, during use, the food is slid from the cutting panel 33 to the slicing knife board 34 and is cut into slices by the slicing blade 341, and the slices are discharged into the containing box 11 via the slice discharge port 342;
referring to FIG. 11, a thick shred knife board 35, wherein the thick shred knife board 35 is provided with a first thick shred blade 351 with cutting edges distributed in a widthwise direction, a thick shred discharge port 352 is formed between the first thick shred blade 351 and the thick shred knife board 35, a plurality of second thick shred blades 353 are arranged at one end of the thick shred knife board 35 that is close to the cutting panel 33, the second thick shred blades 353 are triangles perpendicular to the thick shred knife board 35, cutting edges of the second thick shred blades are arranged on sides close to the cutting panel 33, during use, the food is slid from the cutting panel 33 to the thick shred knife board 35 and is cut by the first thick shred blade 351 and the second thick shred blades 353 jointly at different angles to be cut into thick shreds, and then the thick shreds are discharged into the containing box 11 via the thick shred discharge port 352;
referring to FIG. 12, a thin shred knife board 36, wherein the thin shred knife board 36 is provided with a plurality of staggered thin shred discharge ports 361, a thin shred blade 362 bulging upwards is arranged at one end of each thin shred discharge port 361 that is far away from the cutting panel 33, each thin shred blade 362 is of an arc-shaped structure and has one closed end and one open end, during use, the food is slid from the cutting panel 33 to the thin shred knife board 36 and is cut into thin shreds by the thin shred blades 362, and the thin shreds are discharged into the containing box 11 via the thin shred discharge ports 361;
referring to FIG. 13, a square shred knife board 37, wherein the square shred knife board 37 is provided with a plurality of staggered square shred discharge ports 371, a square shred blade 372 bulging upwards is arranged at one end of each square shred discharge port 371 that is far away from the cutting panel 33, each square shred blade 372 is of a square structure and has one closed end and one open end, during use, the food is slid from the cutting panel 33 to the square shred knife board 37 and is cut into square shreds by the square shred blades 372, and the square shreds are discharged into the containing box 11 via the square shred discharge ports 371;
referring to FIG. 14, a grinding knife board 38, wherein the grinding knife board 38 is provided with a plurality of staggered pulp discharge ports 381, a plurality of grinding blades 382 bulging upwards are arranged around each pulp discharge port 381, during use, the food is placed on the grinding knife board 38 to be rubbed repeatedly and is ground into pulp by the grinding blades 382, and the pulpy food is discharged into the containing box 11 via the pulp discharge ports 381; and
referring to FIG. 15, a threshing knife board 39, wherein the threshing knife board 39 is provided with a through hole, a threshing hole 391 is coaxially formed in the through hole, a plurality of threshing blades 392 are circumferentially arranged on the threshing hole 391, a threshing discharge port 393 is formed between the threshing hole 391 and the through hole, during use, the threshing knife board 39 in the appropriate specifications is selected such that the hole diameter of the threshing hole 391 is roughly the same as the diameter of a corncob, corn is vertically placed into the threshing hole 391 and is pressed downwards, and corn kernels on an outer side of the threshing hole 391 are cut off by the threshing blades 392 and are discharged into the containing box 11 via the threshing discharge port 393.

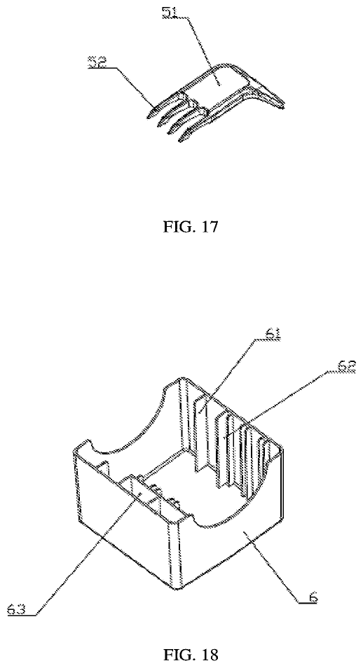

Referring to FIG. 3 and FIG. 16, in order to make the platy cutting device 3 easier to use, the cutter further comprises a propeller 4 matching the platy cutting device 3 for use, wherein the propeller 4 comprises a propeller base 41 capable of spanning the platy cutting device 3, a plurality of vertically arranged pins 42 are arranged in the propeller base 41, a pressing disc 43 is vertically slidably arranged in the propeller base 41, a plurality of through holes allowing the pins 42 to penetrate through are formed in the pressing disc 43, the pressing disc 43 is connected, by means of a plurality of vertical guide columns 44, to a propelling button 45 located above the propeller base 41, and the guide columns 44 vertically penetrate through the propeller base 41.

A method for using the propeller 4 comprises: connecting the pieces of food to the propeller 4 by means of the pins 42, placing the propeller 4 provided with the food on the platy cutting device 3, pushing the propelling button 45 by hand, the propeller 4 driving the food to reciprocate for processing, and after the food is thinned, the propelling button 45 pushing, by means of the pressing disc 43, the food to move downwards so as to avoid the influence of the pins 42 on processing of the food till the end.

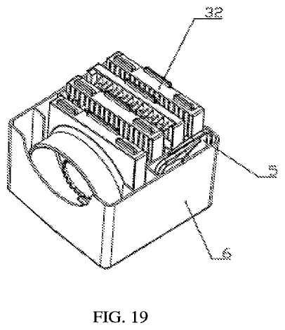

Referring to FIG. 17, FIG. 18 and FIG. 19, the cutter further comprises cleaning teeth 5, wherein the cleaning teeth 5 comprise a handle portion 51 and a toothed portion 52 and are used to clean gaps among the square bumps 25 of the dicing pressing plate 23 and to clean gaps among the blades of the various knife boards; and in order to better store the knife boards, a knife board storage box 6 is detachably arranged in the box body 1 and is divided, by means of barriers 61, into a plurality of knife board storage spaces 62 matching the reticulated knife board 24 and the cutting knife board 32 and cleaning tooth storage spaces 63 matching the cleaning teeth 5.

The embodiments above are only preferred embodiments of the application, and do not limit the scope of protection of the application. Therefore, any equivalent change made according to the structure, shape and principle of the application should be included in the scope of protection of the application.

What is claimed is:

1. A multi-functional cutter, the cutter comprising a box body with an opening formed in an upper end, wherein a drawer type containing box is slidably arranged in the box body; a plurality of functional assemblies match in a replaceable manner at the opening of the box body; the functional assemblies at least comprise a dicing device and a platy cutting device;
the dicing device comprises a dicing base and a dicing gland, the bottom of the dicing base is connected to the box body in a matching manner, the dicing gland is detachably articulated to the dicing base by means of a first locking assembly, a dicing pressing plate is detachably connected to the dicing gland by means of a second locking assembly, a reticulated knife board is detachably connected to the dicing base by means of a third locking assembly, and a plurality of square bumps matching the reticulated knife board are arranged at the bottom of the dicing pressing plate; and
the platy cutting device comprises a cutting bottom plate, the bottom of the cutting bottom plate is connected to the box body in a matching manner, a cutting knife board and a cutting panel are adjacently arranged on the cutting bottom plate, the cutting knife board is detachably connected to the cutting bottom plate by means of a fourth locking assembly, and an adjusting device for adjusting the height of the end of the cutting panel that is adjacent to the cutting knife board is arranged between the cutting bottom plate and the cutting panel.

2. The multi-functional cutter according to claim 1, wherein the first locking assembly comprises a first locking base arranged above the dicing base, a pair of rotating shafts capable of sliding axially is arranged in the first locking base, a pair of rotating shaft holes matching the rotating shafts for locking is formed in an articulated end of the dicing gland, handles for driving the rotating shafts to move inwards are connected to the rotating shafts respectively, and first reset springs for driving the rotating shafts to move outwards are arranged between the rotating shafts and the first locking base respectively.

3. The multi-functional cutter according to claim 1, wherein the second locking assembly comprises a second locking base fixed to the dicing gland, a second locking member is slidably arranged on the second locking base in a lengthwise direction, a second lock tongue is arranged at one end of the second locking member that is close to the dicing pressing plate, a second locking groove matching the second lock tongue for locking is formed at one end of the dicing pressing plate, and a second reset spring for driving the second locking member to slide in a locking direction is arranged between the second locking member and the second locking base.

4. The multi-functional cutter according to claim 1, wherein the third locking assembly comprises a third locking base fixed to the dicing base, a third locking member is slidably arranged on the third locking base in a lengthwise direction, a third lock tongue is arranged at a front end of the third locking member, a third adjusting hole distributed in a widthwise direction is formed in a rear end of the third locking member, the third adjusting hole comprises a locking section and an unlocking section, a front side wall of the locking section is further away from the reticulated knife board than a front side wall of the unlocking section, a third strip-shaped hole corresponding to the third adjusting hole is formed in the dicing base, a third adjusting knob connected to a front side wall of the third adjusting hole in an abutting manner is slidably arranged in the third strip-shaped hole and the third adjusting hole, a third locking groove matching the third lock tongue for locking is formed at a rear end of the reticulated knife board, and a third reset spring for driving the third locking member to move away from the reticulated knife board is arranged between the third locking member and the third locking base.

5. The multi-functional cutter according to claim 1, wherein the fourth locking assembly comprises a fourth lock tongue arranged on the cutting knife board, the fourth lock tongue is arranged at one end of the cutting knife board that is close to the cutting panel, a fourth locking groove matching the fourth lock tongue for locking is formed in the cutting bottom plate, a plurality of elastic clamping blocks clamped and fixed to the cutting bottom plate are arranged at one end of the cutting knife board that is far away from the cutting panel, limiting blocks are arranged above two sides of the fourth lock tongue, and the limiting blocks are connected to the bottom of the cutting panel in an abutting manner in an initial state.

6. The multi-functional cutter according to claim 1, wherein the height adjusting device comprises a sliding plate slidably arranged on the cutting bottom plate in a lengthwise direction, the cutting panel is located above the sliding plate, one end of the cutting panel that is far away from the cutting knife board is articulated with the cutting bottom plate, the other end of the cutting panel is a movable end, a pair of first ribs having gradually-changed stepped surfaces is arranged on a bottom plane of the movable end in a lengthwise direction, second ribs, corresponding to the first ribs, in a widthwise direction are arranged on the sliding plate, the cutting panel has different heights when the second ribs abut against the different stepped surfaces of the first ribs, a guide hole is obliquely formed in the sliding plate, an adjusting plate is slidably arranged in the guide hole by means of an adjusting pin, the adjusting plate drives the sliding plate to move forwards and backwards when moving in the widthwise direction, and a fifth adjusting knob for driving the adjusting plate to move is fixed to the adjusting plate.

7. The multi-functional cutter according to claim 1, wherein the reticulated knife board has different mesh sizes, and the dicing pressing plate having the square bumps matching meshes is selected.

8. The multi-functional cutter according to claim 1, wherein the cutting knife board is selected from following various cutting knife boards including:
a slicing knife board, wherein the slicing knife board is provided with a slicing blade with cutting edges distributed in a widthwise direction, and a slice discharge port is formed between the slicing blade and the slicing knife board;
a thick shred knife board, wherein the thick shred knife board is provided with a first thick shred blade with cutting edges distributed in a widthwise direction, a thick shred discharge port is formed between the first thick shred blade and the thick shred knife board, a plurality of second thick shred blades are arranged at one end of the thick shred knife board that is close to the cutting panel, the second thick shred blades are triangles perpendicular to the thick shred knife board, and cutting edges of the second thick shred blades are arranged on sides close to the cutting panel;
a thin shred knife board, wherein the thin shred knife board is provided with a plurality of staggered thin shred discharge ports, a thin shred blade bulging upwards is arranged at one end of each thin shred discharge port that is far away from the cutting panel, and each thin shred blade is of an arc-shaped structure and has one closed end and one open end;
a square shred knife board, wherein the square shred knife board is provided with a plurality of staggered square shred discharge ports, a square shred blade bulging upwards is arranged at one end of each square shred discharge port that is far away from the cutting panel, and each square shred blade is of a square structure and has one closed end and one open end;
a grinding knife board, wherein the grinding knife board is provided with a plurality of staggered pulp discharge ports, and a plurality of grinding blades bulging upwards are arranged around each pulp discharge port; and
a threshing knife board, wherein the threshing knife board is provided with a through hole, a threshing hole is coaxially formed in the through hole, a plurality of threshing blades are circumferentially arranged on the threshing hole, and a threshing discharge port is formed between the threshing hole and the through hole.

9. The multi-functional cutter according to claim 1, further comprising a propeller matching the platy cutting device for use, wherein the propeller comprises a propeller base capable of spanning the platy cutting device, a plurality of vertically arranged pins are arranged in the propeller base, a pressing disc is vertically slidably arranged in the propeller base, a plurality of through holes allowing the pins to penetrate through are formed in the pressing disc, the pressing disc is connected, by means of a plurality of vertical guide columns, to a propelling button located above the propeller base, and the guide columns vertically penetrate through the propeller base.

10. The multi-functional cutter according to claim 1, further comprising cleaning teeth, wherein the cleaning teeth comprise a handle portion and a toothed portion; and a knife board storage box is detachably arranged in the box body and is divided, by means of barriers, into a plurality of knife board storage spaces matching the reticulated knife board and the cutting knife board and cleaning tooth storage spaces matching the cleaning teeth.
